(19) United States
(12) Patent Application Publication
(10) Pub. No.: US 2007/0028176 A1
(43) Pub. Date: Feb. 1, 2007

(54) Method and system for providing limited access to a locked computing device

(76) Inventors: Jorge L. Perdomo, Boca Raton, FL (US); Von A. Mock, Boynton Beach, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/189,265

(22) Filed: Jul. 26, 2005

(51) Int. Cl. G06F 9/00

(52) U.S. Cl. 715/741

(57) ABSTRACT

A method (100) of providing limited access to a computing device (26) can include limiting (102) access to the computing device by requiring a predetermined user input (e.g., password) during active operation of a screen saver application, presenting (104) a first screen layout having at least one web site link (14) during operation of the screen saver application, granting (106) access to the web site link without requiring the predetermined user input during operation of the screen saver application, and presenting (108) a predetermined website upon activation of the web site link. Access is otherwise denied (110) to the computing device until the predetermined user input is provided. Note, the method can enable (112) a transaction with the predetermined website. The method can further present (114) a targeted screen layout or advertisement in response to receiving information from a user using a short range communication interface.

### FIELD OF THE INVENTION

This invention relates generally to computer programs, and more particularly to a method and system for providing limited access to a locked computing device.

### BACKGROUND OF THE INVENTION

Many screen saver applications have security features requiring a password to gain access to a client device. While a client device is in a screen saver mode or running a screen saver application in a locked state, the client device is essentially useless to anyone without a password. One existing patent by Motorola, Inc., U.S. Pat. No. 6,256,008, describes a method and system of enabling a user to send messages to a wireless device on a client device even when the client device is in a screen saver application. Such application provides additional functionality to a client device that would otherwise be under-utilized without necessarily creating security concerns for the client device.

In the context of a kiosk, an application can provide limited access to information on a particular product or service, yet a passerby will not be able to intelligently and substantively interact with such kiosk in a seamless manner. The kiosk will not know anything about the passerby or their interests. The kiosk will not be able to provide targeted advertising without knowledge of the passerby. Current kiosk technology requires manual entry of data by a user in order for a kiosk to provide relevant information in response to such inputted data.

### SUMMARY OF THE INVENTION

Embodiments in accordance with the present invention can provide a method and system for providing limited access to computer resources to enable limited web content browsing while restricting other uses or privileges to a casual user. Embodiments herein can also enable targeted advertising and transaction completions via such limited access computing device. Targeted advertising can occur in a seamless manner with little or no user interaction.

In a first embodiment of the present invention, a method of providing limited access to a computing device can include the steps of limiting access to the computing device by requiring a predetermined user input during active operation of a screen saver application, presenting a first screen layout having at least one web site link during operation of the screen saver application, granting access to the at least one web site link without requiring the predetermined user input during active operation of the screen saver application, and presenting a predetermined website upon activation of the at least one web site link. Access is otherwise denied to the computing device until the predetermined user input is provided. Note, the method can enable a transaction with the predetermined website. In one variation, the method can further present a targeted screen layout with the predetermined web site link in response to receiving information from a user using a short range communication link such as a Bluetooth communication link. The information from the user can be a user profile.

In a second embodiment of the present invention, another method of providing limited access to a computing device can include the steps of presenting a first screen layout enabling a communication link to at least one predetermined vendor while otherwise maintaining the computing device in a locked state, granting access to the at least one predetermined vendor upon activation of the communication link while maintaining the locked state, and performing a commercial transaction on the communication link while maintaining the locked state. The method can further grant access to at least one predetermined vendor upon activation of the communication link by a user by entering a pin number which can optionally be displayed on the first screen layout. The pin can also enable performing a commercial transaction using such communication link. A targeted screen layout can be presented with a predetermined web site link in response to receiving information such as a user profile from a user using a short range communication link such as a Bluetooth communication link.

In a third embodiment of the present invention, a computing device can include a processor, a display screen coupled to the processor, and a screen saver application running on the computing device that disables complete access to the computing device unless a predetermined user input is provided and provides limited access to predetermined web content via a graphical user interface within the screen saver application. The computing device can further include a short range communication link for receiving a user profile within a predetermined range of the computing device and the computing device can provide targeted advertising on the display screen in response to receiving the user profile. In this regard, the screen saver application can enable a commercial transaction such as a purchase transaction. In one variation, the screen saver application can provide limited access to the predetermined web content upon entering a pin such as a pin displayed on the display screen in a first screen shoot of the application. The pin can also enable the purchase transaction as well. Note, the computing device can be a desktop computer or kiosk device, a laptop computer, a cellular phone, a personal digital assistant, a smart phone or any number of other computing devices.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of an existing screen saver that enables access to a paging device.

FIG. 2 is a graphical user interface enabling limited access to a website while maintaining a computing device in a locked state in accordance with an embodiment of the present invention.

FIG. 3 is a system including a computing device that enables access to web content on a website server while the computing device otherwise remains in a locked state in accordance with an embodiment of the present invention.

FIG. 4 is a system including a computing device enabling targeted advertising based information received on a short range radio frequency link and commercial transactions while the computing device remains in a locked state in accordance with an embodiment of the present invention.

FIG. 5 is a flow chart illustrating a method of providing limited access to a computing device in accordance with an embodiment of the present invention.

FIG. 6 is a flow chart illustrating a method of providing limited access to a computing device in accordance with another embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Referring to FIG. 1, a screen configuration while in a mode of operation of a wireless screen saver as discussed in U.S. Pat. No. 6,256,008 is shown. In this mode, a screen 300 of a computing system is annotated with appropriate messaging and notification functions. The layout includes a personalized message annunciation area 402 in which the system's owner may choose to display a message regarding their availability, location, or the like. A virtual notepad 404 is presented for a user to enter and save a note intended for the system's owner. After entry of a note, a note saved field 408 notifies the system's owner that a note or notes have been saved for later retrieval.

On another side of the layout, a virtual messaging device (e.g., pager or the like) 410 is presented in which a user may enter a numeric or alphanumeric message for transmission to the system owner's pager, or possibly one or more other designated pagers. The virtual messaging device or pager 410 is capable of accepting and displaying a message for transmission to a real messaging device such as a conventional selective call receiver or some other wireless communication device.

The virtual pager 410 also may include a message status field 414, that displays a message length indication responsive to the configuration of the system owner's pager, the system owner's paging service, or the like, such that the message sent will be correctly formatted, transmitted, and received by the designated pager. Additionally, the message status field 414 is used to display the number of wireless messages (e.g., pages) sent when an authorized user reviews messages that were sent from the wireless screen saver.

The layout on screen 300 can also contain several context sensitive function buttons that allow either a casual user (e.g., one without password access to the computer) or an authorized user (e.g., the system's owner) to execute a function such as to “send” a wireless message (page), “clear” a previously entered message (if an error was made), “lock” the screen, “setup” preferences associated with the wireless screen saver (e.g., timeout, paging service provider, destination(s) such as the system owner's pager, or possibly one or more other designated pagers), “about” which provides information such as the copyright and source of origin of the wireless screen saver program, and “exit” which aborts the entry process, returning the display to another screen such as a conventional screen saver screen.

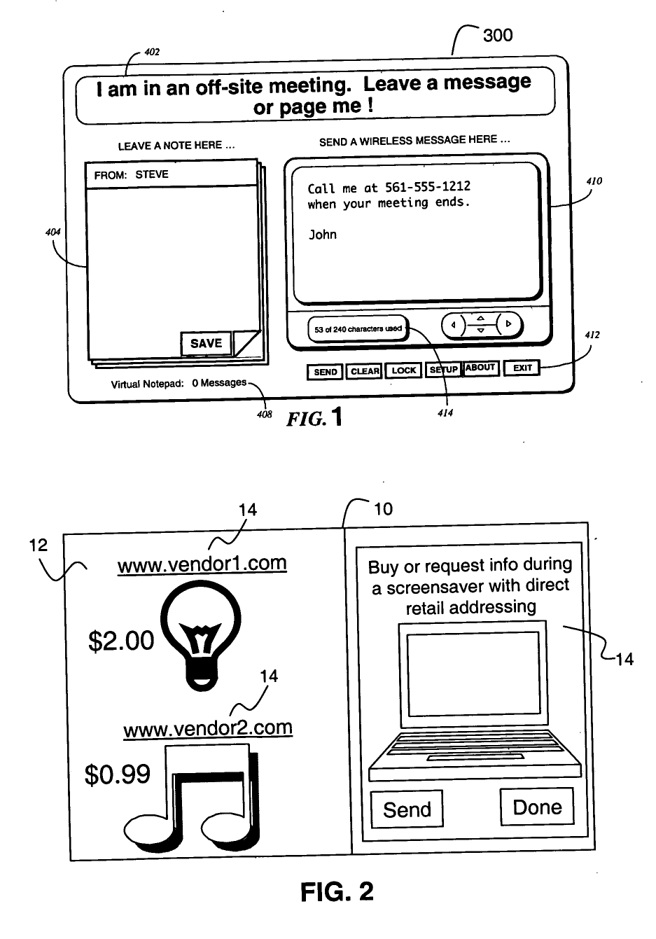

Referring to FIG. 2, a screen 10 illustrates a graphical user interface on a computing device that demonstrates in accordance with an embodiment of the present invention how a computing device can still utilize a screen saver application and further add the ability to download and display advertising or informational images 12 via a computer coupled to a website server. The images can be displayed along with the predefined images stored in the screensaver application and with web links 14 that enable further communication with a particular website or vendor. An authorized end user can enable or disable this function through the screensaver application. Once the application is running it will enable the casual user to surf the internet generally, but the application can be limited and use a smart agent to provide or direct the user to predetermined or preferred websites without actively searching the web generally for products.

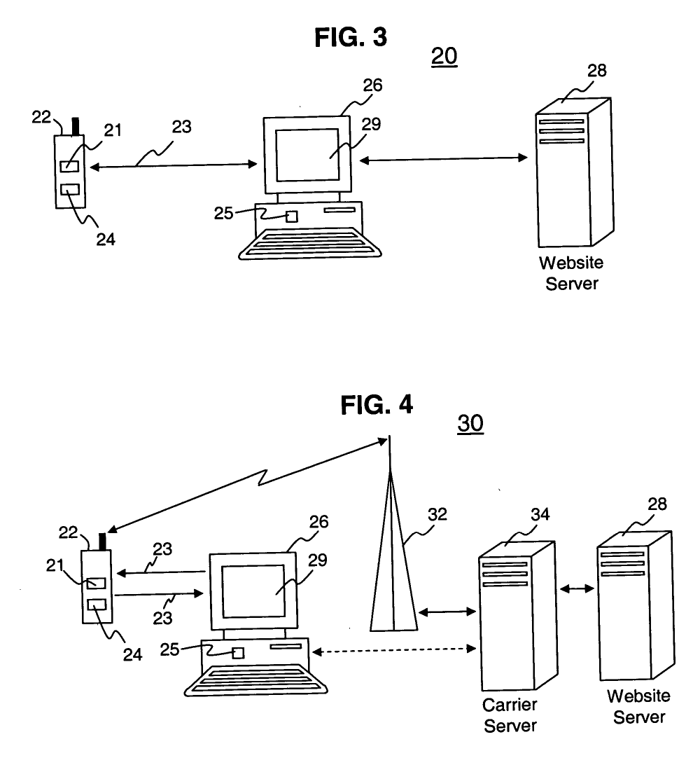

Referring to FIGS. 3 and 4, a communication system 20 or 30 utilizing a computing device 26 such as a desktop computer is shown. The computing device 26 can include a processor 25, a display screen 29 coupled to the processor 25, and a screen saver application running on the computing device that disables complete access to the computing device 26 unless a predetermined user input such as a password is provided. The computing device 26 also provides limited access to predetermined web content via a graphical user interface within the screen saver application without necessarily requiring the password or predetermined user input. The computing device can further include a short range communication link 23 (such as Bluetooth, IRDA, or 802.11b or g for example) for receiving user information such as a user profile within a predetermined range of the computing device 26. The range is typically limited by the type of communication protocol used and the operating environment. The computing device 26 can provide targeted advertising on the display screen 29 in response to receiving the user profile or other user information. The user information can be entered manually as described below, but can also be seamlessly extracted from a memory store 21 within a user device 22 having such a short range wireless communication link or interface such as a Bluetooth transceiver 24. Note, the computing device 26 is not necessarily limited to a desktop computer, but can also be a kiosk device, a laptop computer, a cellular phone, a personal digital assistant, a smart phone or any other number of computing devices and can further include a short range wireless communication interface similar to interface 24.

The application can be programmed via the users' interest into a profile setting, or the user can interrupt the screensaver to enter criteria for a product manually or the screensaver can run randomly with advertisements or other information that has no association to a profile or other user information. Of course, the parameters as to what is advertised or shown and as to what is provided as links is endless. The subjects and/or links can include anything from sports equipment, services, product information, clearance or other discounted bargains from selected retailers or from any retailer based on the user's need for the product. The screensaver application can give the ability to select a criteria or enable the user to select a preferred profile setting for a predetermined search request. In addition, the application profile can optionally store credit card information for direct billing. This billing can be enabled by entering a pin number when the item of interest is displayed along with the user's shipping information which can be all stored and accessible by the profile setting at a particular vendor's website.

For example, the computing device 26 can be linked to a backend server or website 28 such as Amazon.com where a user has a stored profile of past purchases which can be utilized to suggest advertisement for images on the screen saver application. Once an item is displayed on the screensaver, the user can purchase the item by pressing a key on the keyboard and begin typing into a messaging user interface that resides on the user interface of the screen saver similar to the virtual messaging device 410 of FIG. 1. If an existing profile exists (either locally at the computing device 26, but more likely at the vendor's website (28)), the user might only need to enter their predetermined pin in order to send their billing and shipping information through direct addressing to the retailer. Instead of entering their pin which will invoke the purchasing sequence, the user can alternatively request additional information on the product displayed by typing into the messaging user interface or selecting a soft key displayed on the messaging user interface via the mouse control or other available user input (e.g., speech recognition). When requesting information the profile can send address information or automatically download a file, which can be printed (if the screen saver settings enable such function) or displayed by a local program on the computer (again if the screen saver settings enable such function). This function can enable confirmation or purchases with receipts if desired.

In another aspect, a screen saver-messaging terminal such as a kiosk can be placed in a public venue where people will generally stroll by. In this use case, a mobile device 22 having short-range capability can communicate with the screen saver-messaging terminal (26) to provide directed or targeted advertisements or messages. The communication exchange between the mobile device 22 and the terminal 26 extracts profile information of what a particular individuals' current shopping experience or needs are likely to be and can further provide an identification code that accesses a backend server 28 to determine desired advertisements. Note, as shown in FIG. 4, the communication link to the backend server 28 does not necessarily need to be a wired link, but can be a wireless link. The wireless link can be from the computing device 26 to the server 28, but can certainly also be communicated via the user's very own mobile device 22 via a communication link 32 and a carrier server 34 that can be coupled to the backend server 28.

In another scenario, a user having an online America Online (AOL) Instant Messaging account including a buddy list of friends and family can use AOL or other suitable Internet Service Provider (ISP) to track the spending and/or purchasing habits of the members of the buddy list and can also query for wish list items that such buddies may want. At some point in time on the screen saver application, an indication can be provided that an item currently being viewed is also an item a friend or family member is also interested in.

This application enables purchasing or requesting information without actively surfing the web. The user can enable a profile for selected products, interest or clearance items to allow surrogate surfing. Such an application enables a user to gracefully view a computer monitor until an item of particular interest is displayed prompting the user to purchase or request additional information.

In a desktop application, a messaging user interface within the screen saver can enable direct retail purchasing and addressing instead of messaging to an individual pager. The desktop owner or user or another user with an appropriate user access can then purchase product from a particular vendor. If the desktop owner or a general or casual user wishes to request additional information, they can enter the request into the messaging interface or select a softkey within the screen saver application for a quick request. In the event the screensaver application is displaying the advertised product and they wish to send a message to the desktop owner, the user can exit or possibly press the “escape” button and the screensaver application can return the user to a messaging interface that enables messaging directly to the desktop owner similar to what is shown in FIG. 1. Alternatively, the messaging interface enabling messaging to the owner of the computing device 26 can remain as part of main screensaver screen.

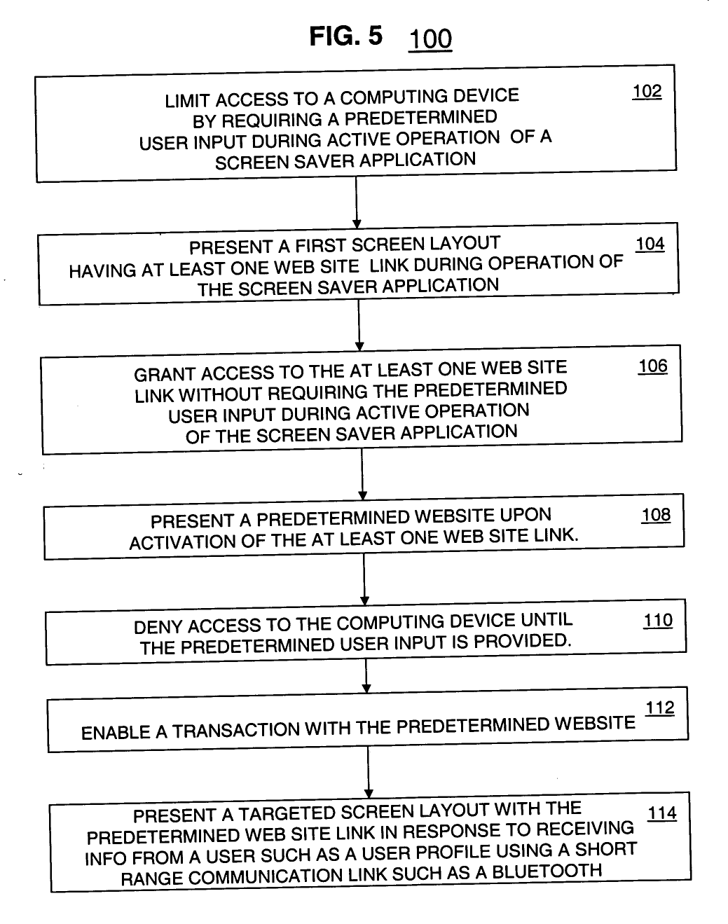

Referring to FIG. 5, a method 100 of providing limited access to a computing device can include the step 102 of limiting access to the computing device by requiring a predetermined user input such as a password during active operation of a screen saver application, presenting a first screen layout having at least one web site link during operation of the screen saver application at step 104, granting access to the at least one web site link without requiring the predetermined user input during active operation of the screen saver application at step 106, and presenting a predetermined website upon activation of the at least one web site link at step 108. Access is otherwise denied to the computing device at step 110 until the predetermined user input is provided. Note, the method 100 can enable a transaction with the predetermined website as shown at step 112. In one variation as shown at step 114, the method 100 can further present a targeted screen layout with the predetermined web site link in response to receiving information from a user using a short range communication link such as a Bluetooth communication link. The information from the user can be a user profile.

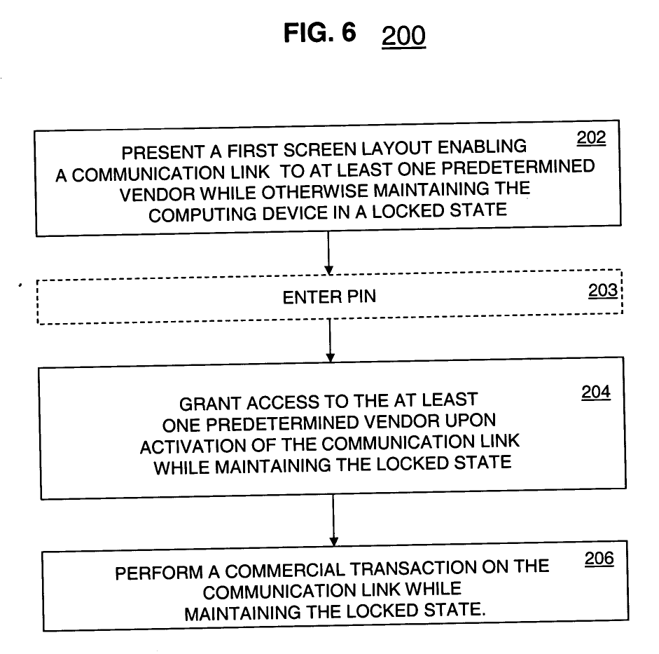

Referring to FIG. 6. another method 200 of providing limited access to a computing device can include the step 202 of presenting a first screen layout enabling a communication link to at least one predetermined vendor while otherwise maintaining the computing device in a locked state, granting access to the at least one predetermined vendor upon activation of the communication link while maintaining the locked state at step 204, and performing at step 206 a commercial transaction on the communication link while maintaining the locked state. The method can further grant access to at least one predetermined vendor upon activation of the communication link by a user by entering a pin number at step 203 which can optionally be displayed on the first screen layout. (The pin can be pre-stored at the vendor's website server). The pin can also enable performing a commercial transaction using such communication link. A targeted screen layout can be presented with a predetermined web site link in response to receiving information such as a user profile from a user using a short range communication link such as a Bluetooth communication link.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of providing limited access to a computing device, comprising:
limiting access to the computing device by requiring a predetermined user input during active operation of a screen saver application;
presenting a first screen layout having at least one web site link during operation of the screen saver application;
granting access to the at least one web site link without requiring the predetermined user input during active operation of the screen saver application; and
presenting a predetermined website upon activation of the at least one web site link.

2. The method of claim 1, wherein the method further comprises the step of otherwise denying access to the computing device until the predetermined user input is provided.

3. The method of claim 1, wherein the method further comprises enabling a transaction with the predetermined website.

4. The method of claim 1, wherein the method further comprises the step of presenting a targeted screen layout with the predetermined web site link in response to receiving information from a user using a short range communication link.

5. The method of claim 4, wherein the step of receiving information comprises receiving a user profile from the user via the short range communication link.

6. The method of claim 5, wherein the short range communication link is a Bluetooth communication link.

7. A method of providing limited access to a computing device, comprising:
presenting a first screen layout enabling a communication link to at least one predetermined vendor while otherwise maintaining the computing device in a locked state;
granting access to the at least one predetermined vendor upon activation of the communication link while maintaining the locked state; and
performing a commercial transaction on the communication link while maintaining the locked state.

8. The method of claim 7, wherein the method further comprises the step of granting access to the at least one predetermined vendor upon activation of the communication link by a user by entering a pin number.

9. The method of claim 7, wherein the method further comprises the step of enabling the step of performing the commercial transaction by a user by entering a pin number.

10. The method of claim 7, wherein the method further comprises the step of presenting a targeted screen layout with a predetermined web site link in response to receiving information from a user using a short range communication link.

11. The method of claim 10, wherein the step of receiving information comprises receiving a user profile from the user via the short range communication link.

12. A computing device, comprising:
a processor;
a display screen coupled to the processor; and
a screen saver application running on the computing device that disables complete access to the computing device unless a predetermined user input is provided and provides limited access to predetermined web content via a graphical user interface within the screen saver application.

13. The computing device of claim 12, wherein the computing device further comprises short range communication interface for receiving a user profile within a predetermined range of the computing device.

14. The computing device of claim 13, wherein the computing device provides targeted advertising on the display screen in response to receiving the user profile via the short range communication interface.

15. The computing device of claim 12, wherein the computing device is selected among a laptop computer, a desk top computer, a cellular phone, a personal digital assistant, and a smart phone.

16. The computing device of claim 12, wherein the screen saver application provides limited access to the predetermined web content upon entering a pin displayed on the display screen in a first screen shot of the application.

17. The computing device of claim 12, wherein the screen saver application enables a purchase transaction.

18. The computing device of claim 17, wherein the screen saver application enables the purchase by the user by entering a pin number.

19. A machine-readable storage, having stored thereon a computer program having a plurality of code sections executable by a machine for causing the machine to perform the steps of:
presenting a first screen layout enabling a communication link to at least one predetermined vendor while otherwise maintaining the computing device in a locked state;
granting access to the at least one predetermined vendor upon activation of the communication link while maintaining the locked state; and
performing a commercial transaction on the communication link while maintaining the locked state.

20. The machine readable storage of claim 19, wherein the computer program further comprises a plurality of code sections for causing the machine to present a targeted screen layout with a predetermined web site link in response to receiving information from a user using a short range communication link.
